(19) United States
(12) Patent Application Publication
(10) Pub. No.: US 2020/0355948 A1
(43) Pub. Date: Nov. 12, 2020

(54) FRAME SEALANT AND LIQUID CRYSTAL DISPLAY PANEL

(71) Applicant: Shenzhen China Star Optoelectronics Technology Co., Ltd., Shenzhen, Guangdong (CN)

(72) Inventor: Dong LIAO, Shenzhen (CN)

(73) Assignee: Shenzhen China Star Optoelectronics Technology Co., Ltd., Shenzhen, Guangdong (CN)

(21) Appl. No.: 16/607,176

(22) PCT Filed: May 27, 2019
(86) PCT No.: PCT/CN2019/088659

§ 371 Date: Oct. 22, 2019

(30) Foreign Application Priority Data
May 10, 2019 (CN) 201910390515.X

(51) Int. Cl. G02F 1/1339; C08K 3/08; B32B 17/06; B32B 7/14; B32B 7/05

(52) U.S. Cl. CPC G02F 1/1339; C08K 3/08; B32B 17/068; B32B 7/14; B32B 7/05; B32B 2307/42; C08K 2201/013; C08K 2201/001; C08K 2003/0831; B32B 2457/202; B32B 2307/202; G02F 2202/28

(57) ABSTRACT

The present invention provides a frame sealant and a liquid crystal display panel. The frame sealant includes colloidal material and flexible conductive micro particles distributed in the colloidal material. A maximum compression deformation rate of the flexible conductive micro particles is greater than 60%. The present invention, by using the flexible conductive micro particles with the maximum compression deformation rate being greater than 60% to replace conventional conductive gold balls and spacer particles, makes the flexible conductive micro particles to has both cell gap supporting function and electrical conducting function and can lower difficulty of particle diameter selection to prevent poor products due to inadequate particle diameter selection.

### FIELD OF INVENTION

The present invention relates to a field of display technologies, especially to a frame sealant and a liquid crystal display panel.

### BACKGROUND OF INVENTION

With the development of display technologies, flat display devices such as liquid crystal displays (LCDs) are widely used in mobile phones and televisions, personal digital assistants, digital cameras, notebook computers, desktop computers and other consumer electronics products because of high image quality, power saving, thin body and wide application extent, and have become the mainstream in display devices.

Most of conventional liquid crystal display devices in the market are backlight type liquid crystal display devices, each of which includes a liquid crystal display panel and a backlight module. A working principle of the liquid crystal display panel is disposing liquid crystal molecules between two parallel glass substrates. Between the glass substrates vertical and horizontal wires are disposed, and a direction of the liquid crystal molecules are changed by electrification to refract light of the backlight module to generate images.

Usually the liquid crystal display panel is constituted by a color filter (CF) substrate, thin film transistor (TFT) substrate, and a liquid crystal frame sealant sandwiched between the color filter substrate and the thin film transistor substrate. Generally, a manufacturing method thereof includes: a front stage array process (thin film, yellow light, etching and film releasing processes), a middle stage cell process (fitting of the TFT substrate and the CF substrate), and a backstage module assembling process (lamination of the drive IC and the printed circuit board). The front stage array process is mainly configured to form the TFT substrate to control motion of the liquid crystal molecules. The middle stage cell process is mainly configured to add liquid crystal between the TFT substrate and the CF substrate. The backstage module assembling process is mainly configured for lamination of the drive IC and integration of the printed circuit board such that the liquid crystal molecules are driven to rotate for image display.

A frame sealant used by a conventional liquid crystal display panel usually includes colloidal material (main seal), spacer particles (spacers) distributed in the colloidal material, and conductive gold balls (Au balls) distributed in the colloidal material. Mixture thereof is implemented based on a mass ratio of colloidal material:spacer particles:conductive gold balls=100:1:2. Such frame sealant contains the spacer particles and the conductive gold balls. The spacer particles have a function for supporting the upper and lower substrates to keep a liquid crystal cell gap. The conductive gold balls have a function for electrically connecting the upper and lower electrodes. A topography of an edge of the liquid crystal display panel is complex, particle diameter selection of the spacer particles and the conductive gold balls greatly affect stability of support and electrical conduction. Particle diameter selection for the frame sealant containing both the spacer particles and the conductive gold balls is comparatively difficult because functions and topography characteristics of the both kinds of the particles need to be considered simultaneously. Furthermore, combination of experiment conditions also become complicated accordingly. If selected conductive gold balls are excessive greater, it will result in that the spacer particles loss compression ability to cause the spacer particles to fail to provide compressing and supporting functions, which further results gap mura. If the selected conductive gold balls are excessive less, it will result in poor electrical conduction.

### SUMMARY OF INVENTION

An objective of the present invention is to provide a frame sealant that employs flexible conductive micro particles with a maximum compression deformation rate being greater than 60% to replace conventional conductive gold balls and spacer particles such that particle diameter difficulty of selection can be lowered to prevent poor products resulting from inadequate particle diameter selection.

The objective of the present invention is also to provide a liquid crystal display panel including a frame sealant employing flexible conductive micro particles with a maximum compression deformation rate being greater than 60% to replace conventional conductive gold balls and spacer particles such that particle diameter difficulty of selection can be lowered to prevent poor products resulting from inadequate particle diameter selection.

To achieve the above objective, the present invention provides a frame sealant, comprising colloidal material and flexible conductive micro particles distributed in the colloidal material, a maximum compression deformation rate of the flexible conductive micro particles is greater than 60%.

A mass ratio of the colloidal material and the flexible conductive micro particles is 50:1-50:1.25.

A particle diameter of each of the flexible conductive micro particles is 3 um-8.5 um.

Each of the flexible conductive micro particles comprises a core particle and a conductive layer attached to a surface of the core particle, and material of the core particle is acrylic resin.

The present invention also provides a liquid crystal display panel, comprising: an upper substrate and a lower substrate disposed opposite to each other, a frame sealant disposed between the upper substrate and the lower substrate and configured to sealingly connect the upper substrate and the lower substrate, and a liquid crystal layer disposed in a space that is located between the upper substrate and the lower substrate and is enclosed by the frame sealant; and the frame sealant comprises colloidal material and flexible conductive micro particles distributed in the colloidal material, and a maximum compression deformation rate of the flexible conductive micro particles is greater than 60%.

A mass ratio of the colloidal material and the flexible conductive micro particles is 50:1-50:1.25.

A particle diameter of each of the flexible conductive micro particles is 3 um-8.5 um.

Each of the flexible conductive micro particles comprises a core particle and a conductive layer attached to a surface of the core particle, and material of the core particle is acrylic resin.

The upper substrate is a color filter substrate, and the lower substrate is an array substrate.

A first electrode is disposed on a side of the upper substrate facing the lower substrate, a second electrode is disposed on a side of the lower substrate facing the upper substrate, and the first electrode and the second electrode are electrically connected to each other by the flexible conductive micro particles.

Advantages of the present invention are as follows: The present invention provides a frame sealant, including a frame sealant, comprising colloidal material and flexible conductive micro particles distributed in the colloidal material, a maximum compression deformation rate of the flexible conductive micro particles is greater than 60%. By using the flexible conductive micro particles with the maximum compression deformation rate over 60% to replace conventional conductive gold balls and spacer particles, difficulty of selection of the particle diameter can be lowered to prevent poor products resulting from inadequate selection of the particle diameter. The present invention also provides a liquid crystal display panel that is able to lower difficulty of selection of the particle diameter to prevent poor products due to inadequate particle diameter selection.

### DESCRIPTION OF DRAWINGS

In order to further understand the features and technical contents of the present invention, please refer to the following detailed description and drawings of the present invention. The drawings are only provided for reference and explanation, and are not intended to limit the present invention.

In the drawings:

FIG. 1 is a schematic view of a frame sealant of the present invention;

FIG. 2 is a schematic view of flexible conductive micro particles of the frame sealant of the present invention; and

FIG. 3 is a schematic view of a liquid crystal display panel of the present invention.

### DETAILED DESCRIPTION OF PREFERRED EMBODIMENTS

In order to further explain the technical means and effects of the present invention, the following description is presented for preferred embodiment of the present invention and its accompanying drawings.

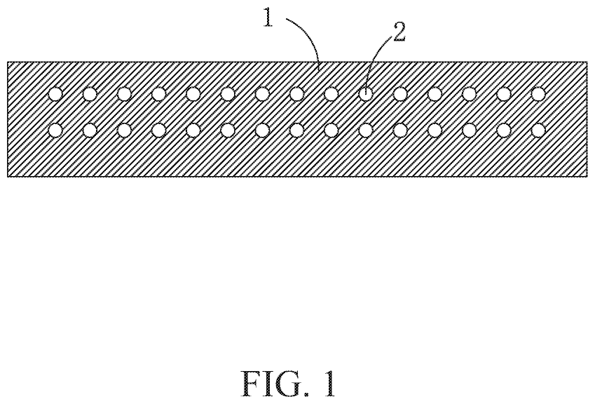

With reference to FIG. 1, the present invention provides a frame sealant comprising colloidal material 1 and flexible conductive micro particles 2 distributed in the colloidal material 1. A maximum compression deformation rate of the flexible conductive micro particles 2 is greater than 60%.

Specifically, the frame sealant is manufactured by mixing the flexible conductive micro particles 2 and the colloidal material 1 in a specific proportion. The frame sealant contains no spacer particles, and the frame sealant, when used in the liquid crystal display panel, directly supports a liquid crystal cell gap by the flexible conductive micro particles 2. Furthermore, the flexible conductive micro particles 2 is also configured to connect upper and lower electrodes. In other words, the flexible conductive micro particles 2 has both the functions of conductive gold balls and spacer particles of conventional technologies to achieve maintenance of supporting and electrical conducting functions of the frame sealant disposed only one kind of particles. Furthermore, because only one kind of particles is disposed, performing particle diameter selection is easier than performing the same under a condition of two kinds of particles as in the prior art, which can prevent poor products due to inadequate particle diameter selection.

Specifically, a mass ratio of the colloidal material 1 and the flexible conductive micro particles 2 is 50:1-50:1.25.

Specifically, the particle diameter of the flexible conductive micro particles 2 can be selected from 3 to 100 um. Preferably, a particle diameter of the flexible conductive micro particles 2 is 3 um-8.5 um.

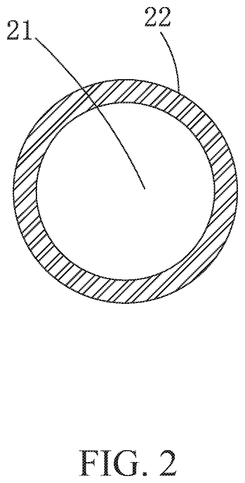

Specifically, with reference to FIG. 2, each of the flexible conductive micro particles 2 includes a core particle 21 and a conductive layer 22 attached to a surface of the core particle 21. Material of the core particle 21 is acrylic resin. Material of the conductive layer 22 is gold or other conductive material. Employing acrylic resin as the core particle 21 of flexible conductive micro particle 2 can enhance compression deformation ability of the flexible conductive micro particles 2 such that the maximum compression deformation rate of the flexible conductive micro particles 2 is greater than 60%. Of course it is not intended to limit the present invention. In other embodiment of the present invention, the core particle 21 can also employ other suitable material as long as it can ensure the maximum compression deformation rate of the flexible conductive micro particles 2 to be greater than 60%.

Preferably, the flexible conductive micro particles 2 is spherical or elliptical.

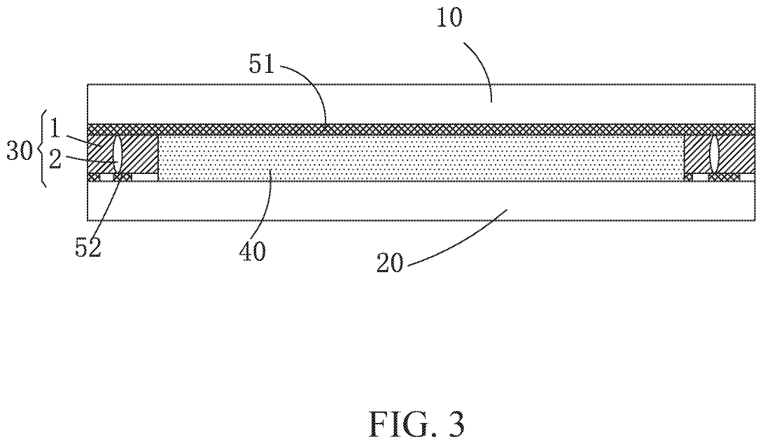

With reference to FIGS. 1 and 3, the present invention also provides a liquid crystal display panel including: an upper substrate 10 and a lower substrate 20 disposed opposite to each other, a frame sealant 30 disposed between the upper substrate 10 and the lower substrate 20 and configured to sealingly connect the upper substrate 10 and the lower substrate 20, a liquid crystal layer 40 disposed in a space that is located between the upper substrate 10 and the lower substrate 20 and is enclosed by the frame sealant 30. The frame sealant 30 includes colloidal material 1 and flexible conductive micro particles 2 distributed in the colloidal material 1. A maximum compression deformation rate of the flexible conductive micro particles 2 is greater than 60%.

Specifically, the frame sealant 30 is manufactured by mixing the flexible conductive micro particles 2 and the colloidal material 1 in a specific proportion. The frame sealant 30 contains no spacer particles, and the frame sealant 30, when used in the liquid crystal display panel, directly supports a liquid crystal cell gap by the flexible conductive micro particles 2. Furthermore, the flexible conductive micro particles 2 is also configured to connect upper and lower electrodes. In other words, the flexible conductive micro particles 2 has both the functions of conductive gold balls and spacer particles of conventional technologies to achieve maintenance of supporting and electrical conducting functions of the frame sealant 30 disposed only one kind of particles. Furthermore, because only one kind of particles is disposed, performing particle diameter selection is easier than performing the same under a condition of two kinds of particles as in the prior art, which can prevent poor products due to inadequate particle diameter selection.

Specifically, a mass ratio of the colloidal material 1 and the flexible conductive micro particles 2 is 50:1-50:1.25.

Specifically, the particle diameter of the flexible conductive micro particles 2 can be selected from 3 to 100 um. Preferably, a particle diameter of the flexible conductive micro particles 2 is 3 um-8.5 um.

Specifically, with reference to FIG. 2, each of the flexible conductive micro particles 2 includes a core particle 21 and a conductive layer 22 attached to a surface of the core particle 21. Material of the core particle 21 is acrylic resin. Material of the conductive layer 22 is gold or other conductive material. Employing acrylic resin as the core particle 21 of flexible conductive micro particle 2 can enhance compression deformation ability of the flexible conductive micro particles 2 such that the maximum compression deformation rate of the flexible conductive micro particles 2 is greater than 60%. Of course it is not intended to limit the present invention. In other embodiment of the present invention, the core particle 21 can also employ other suitable material as long as it can ensure the maximum compression deformation rate of the flexible conductive micro particles 2 to be greater than 60%.

Preferably, the flexible conductive micro particles 2 is spherical or elliptical.

Specifically, the upper substrate 10 is a color filter substrate, and the lower substrate 20 is an array substrate.

Specifically, a first electrode 51 is disposed on a side of the upper substrate 10 facing the lower substrate 20, a second electrode 52 is disposed on a side of the lower substrate 20 facing the upper substrate 10, and the first electrode 51 and the second electrode 52 are electrically connected to each other by the flexible conductive micro particles 2.

In the liquid crystal display panel, the flexible conductive micro particles 2 in the frame sealant 30 has both the electrical conducting function and supporting function, not only can connect the first electrode 51 and the second electrode 52, but also can support a cell gap between the upper and lower substrates. Replacing conductive gold balls and spacer particles of the prior art with the flexible conductive micro particles 2 can lower difficulty of particle diameter selection of the particles in the frame sealant to effectively prevent poor products due to inadequate particle diameter selection.

As described above, the present invention provides a frame sealant, including a frame sealant, comprising colloidal material and flexible conductive micro particles distributed in the colloidal material, a maximum compression deformation rate of the flexible conductive micro particles is greater than 60%. By using the flexible conductive micro particles with the maximum compression deformation rate over 60% to replace conventional conductive gold balls and spacer particles, difficulty of selection of the particle diameter can be lowered to prevent poor products resulting from inadequate selection of the particle diameter. The present invention also provides a liquid crystal display panel that is able to lower difficulty of selection of the particle diameter to prevent poor products due to inadequate particle diameter selection.

As described above, various other changes and modifications can be made by a person of ordinary skill in the art in light of the invention and the technical concept of the present invention, and all such changes and modifications are within the scope of the present invention.

What is claimed is:

1. A frame sealant, comprising colloidal material and flexible conductive micro particles distributed in the colloidal material, a maximum compression deformation rate of the flexible conductive micro particles is greater than 60%.

2. The frame sealant as claimed in claim 1, wherein a mass ratio of the colloidal material and the flexible conductive micro particles is 50:1-50:1.25.

3. The frame sealant as claimed in claim 1, wherein a particle diameter of each of the flexible conductive micro particles is 3 um-8.5 um.

4. The frame sealant as claimed in claim 1, wherein each of the flexible conductive micro particles comprises a core particle and a conductive layer attached to a surface of the core particle, and material of the core particle is acrylic resin.

5. A liquid crystal display panel, comprising: an upper substrate and a lower substrate disposed opposite to each other, a frame sealant disposed between the upper substrate and the lower substrate and configured to sealingly connect the upper substrate and the lower substrate, and a liquid crystal layer disposed in a space that is located between the upper substrate and the lower substrate and is enclosed by the frame sealant; and the frame sealant comprises colloidal material and flexible conductive micro particles distributed in the colloidal material, and a maximum compression deformation rate of the flexible conductive micro particles is greater than 60%.

6. The liquid crystal display panel as claimed in claim 5, wherein a mass ratio of the colloidal material and the flexible conductive micro particles is 50:1-50:1.25.

7. The liquid crystal display panel as claimed in claim 5, wherein a particle diameter of each of the flexible conductive micro particles is 3 um-8.5 um.

8. The liquid crystal display panel as claimed in claim 5, wherein each of the flexible conductive micro particles comprises a core particle and a conductive layer attached to a surface of the core particle, and material of the core particle is acrylic resin.

9. The liquid crystal display panel as claimed in claim 5, wherein the upper substrate is a color filter substrate, and the lower substrate is an array substrate.

10. The liquid crystal display panel as claimed in claim 9, wherein a first electrode is disposed on a side of the upper substrate facing the lower substrate, a second electrode is disposed on a side of the lower substrate facing the upper substrate, and the first electrode and the second electrode are electrically connected to each other by the flexible conductive micro particles.
